(19) United States
(12) Patent Application Publication
(10) Pub. No.: US 2016/0025653 A1
(43) Pub. Date: Jan. 28, 2016

(54) BORESCOPE APPARATUS AND A METHOD OF USING SAME

(71) Applicants: Mohammad JALILIAN, (US); Reza ZOKAEI, (US)

(72) Inventors: MOHAMMAD JALILIAN, San Jose, CA (US); REZA ZOKAEI, Santa Clara, CA (US)

(73) Assignee: Vidtek Associates NV, Inc., Sparks, NV (US)

(21) Appl. No.: 14/775,567

(22) PCT Filed: Mar. 7, 2014
(86) PCT No.: PCT/US14/22020

§ 371 Date: Sep. 11, 2015

Related U.S. Application Data
(60) Provisional application No. 61/790,617, filed on Mar. 15, 2013.

(51) Int. Cl. G01N 21/954; H04N 5/225

(52) U.S. Cl. CPC G01N 21/954; H04N 5/2253; H04N 2005/2255; G01N 2021/9544

(57) ABSTRACT

The present invention relates generally to a borescope or an inspection, scope apparatus and a method of using sane. More particularly, the invention encompasses a borescope having a hollow rigid insertion tube that is mated with a main control unit, or main body. The hollow insertion tube has at least one image sensor, and at least one LED or light source at the distal end of the probing tube to provide image and other information to the main control unit or main body. An opening is made in the wall of the structure to be inspected, and the hollow rigid probe is inserted, and with the light source activated, images within the structure cavity are obtained. After the internal inspection of the cavity has been completed, the probe is extracted, and the hole is closed. The invention also provides a method of using the inventive borescope apparatus.

### CROSS-REFERENCE TO RELATED APPLICATION

The instant patent application claims priority to and the benefit of pending U.S. Provisional Patent Application Ser. No. 61/790,617, filed on Mar. 15, 2013, titled “BORESCOPE APPARATUS AND A METHOD OF USING SAME,” the entire disclosure of which provisional application is incorporated herein by reference.

### FIELD OF THE INVENTION

The present invention relates generally to a borescope or an inspection scope apparatus and a method of using same. More particularly, the invention encompasses a borescope having a hollow rigid insertion tube that is mated with a main control unit or main body. The hollow insertion tube has at least one image sensor, and at least one LED or light source at the distal end of the probing tube to provide image and other information to the main control unit or main body. An opening is made in the wall of the structure to be inspected, and the hollow rigid probe is inserted, and with the light source activated, images within the structure cavity are obtained. After the internal inspection of the cavity has been completed, the probe is extracted, and the hole is closed. The invention also provides a method of using the inventive borescope apparatus.

### BACKGROUND INFORMATION

Borescopes have been used in the industry for a variety of reasons, and they come in many shapes, sizes, and other physical features and attributes.

Today for the purpose of inspecting or looking inside of a typical existing closed wall or ceiling in a building structure, especially between studs, a flexible borescope would normally be used, which typically requires a large access hole or opening to be made in the wall, and since the camera attached to the end of its flexible hose is looking forward, the flexible segment needs to be bent close to 90 degrees in order to look within the cavity of a wall or ceiling. This bending requires a hole or opening somewhat larger than the diameter of the camera head of a typical inspection camera to be created in the wall surface in order for the scope to be maneuvered inside of the wall. Having to create a large opening or hole means that a larger patching and repair job needs to be handled by a typical building contractor or building owner after the inspection work has been done.

This invention improves on the deficiencies of the prior art and provides an inventive borescope apparatus and a method of using same.

### PURPOSES AND SUMMARY OF THE INVENTION

The invention is a novel borescope apparatus and a method of using same.

Therefore, one purpose of this invention is to provide a borescope that can be used to inspect interior surfaces of structures that are difficult to access.

Another purpose of this invention is to provide a borescope that can be used to inspect internal components of an existing structure with minimal disassembly or destruction of the internal components of the structure to be inspected.

Yet another purpose of this invention is to provide a borescope that can be extended through a hole or an aperture, and which would relay images of the internal components of the structure under inspection onto a monitor or screen.

Still yet another purpose of this invention is to provide a borescope that can be extended through a hole or an aperture, and where a light source can be activated to get better images of the internal components of the structure under inspection.

Therefore, in one aspect this invention comprises a borescope apparatus, comprising;

(a) a main body, said main body having a first surface, a second surface, and a peripheral wall between said first surface and said second surface;
(b) a hollow rigid insertion tube having a proximal end, and a distal end, wherein said proximal end of said hollow rigid insertion tube is axially securely mated with said second surface of said main body; and
(c) wherein said distal end has at least one first opening for at least one light source, and at least one second opening for at least one imaging sensor.

In another aspect this invention comprises a method of inspecting a cavity in a structure, comprising the steps of;

(a) making a hole in said structure to access said cavity in said structure;
(b) inserting a distal end of a hollow rigid probe tube of a borescope inside said hole sufficient distance inside said cavity, and wherein said borescope has a main body secured to a proximal end of said hollow rigid probe tube, said distal end of said hollow rigid probe tube having at least one light source and at least one image sensor;
(c) activating said at least one light source, and said at least one imaging sensor to conduct internal inspection of said cavity; and
(d) removing said hollow rigid probe tube upon completion of said internal cavity inspection, and closing said hole in said structure.

### BRIEF DESCRIPTION OF THE DRAWINGS

FIG. 1A, illustrates a side perspective view of an inventive borescope apparatus, according to one embodiment of this invention.

FIG. 1B, illustrates an enlarged distal view of the inventive borescope apparatus of FIG. 1A.

FIG. 2, illustrates a perspective view of the borescope apparatus showing a video screen, and related components.

FIG. 3, illustrates a side cut-away view of the borescope apparatus showing the probing tube as inserted through a wall.

FIG. 4, illustrates a perspective view of a borescope apparatus, according to another embodiment of this invention.

FIG. 5, illustrates a perspective view of a borescope apparatus, according to yet another embodiment of this invention.

### DETAILED DESCRIPTION

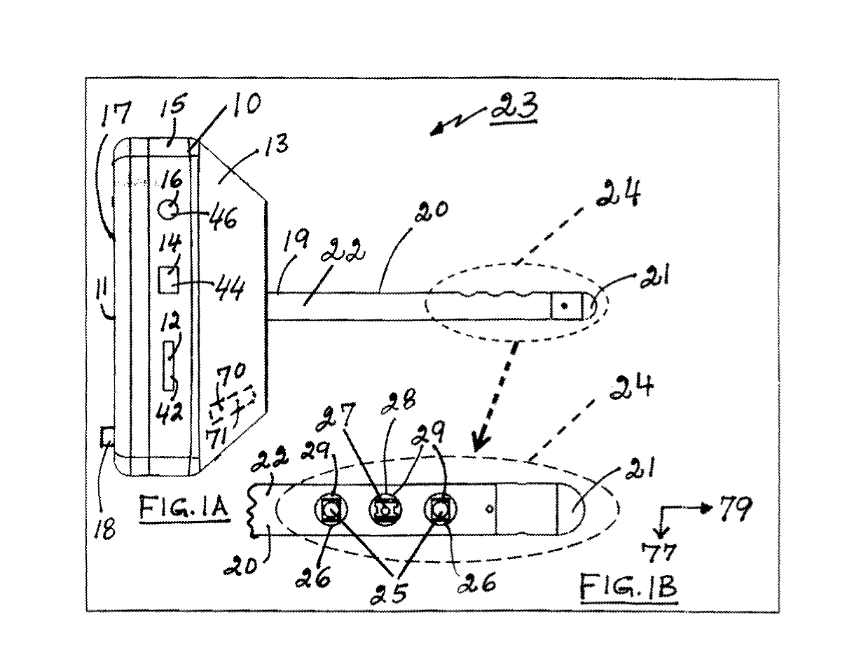

The inventive borescope apparatus and a method of using same will now be discussed with reference to FIGS. 1A through 5. Although the scope of the present invention is much broader than any particular embodiment, a detailed description of the preferred embodiment follows together with drawings. These drawings are for illustration purposes only and are not drawn to scale. Like numbers represent like features and components in the drawings.

Furthermore, this inventive borescope can be used to inspect interior of structures that are difficult to access, especially, if it is desired to inspect internal components with minimal disassembly or destruction of the internal components of the structure to be inspected. Apertures or holes can be defined in the walls of the structure to allow for the passage of a tip of the borescope. The borescope can be extended through these holes or apertures and relay images of the components to a monitor. After the internal inspection has been completed the inventive borescope probe is removed, and the holes or apertures are closed or plugged.

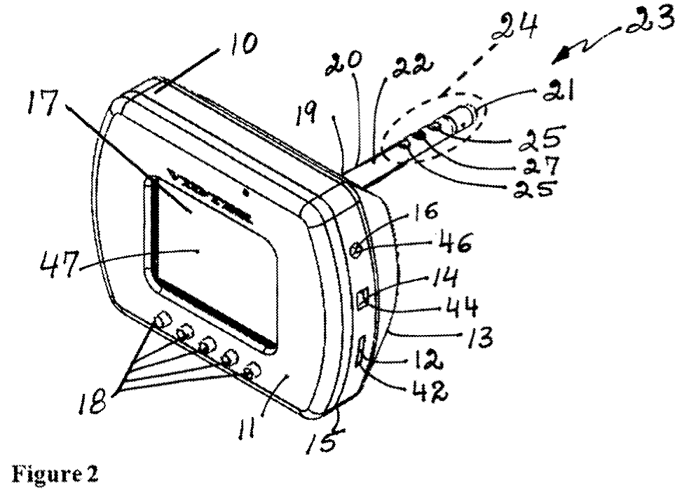

FIG. 1A, illustrates a side perspective view of an inventive borescope or an inspection scope apparatus 23, according to one embodiment of this invention. The borescope 23, comprises of a main body 10, and a probing tube or unit 20. The main body 10, has a first face or surface 11, and a second face or surface 13, and a peripheral wall 15, between the first surface 11, and the second surface 13. The main body 10, preferably has a battery compartment 71, to securely hold at least one battery 70, at least one slot or port 12, such as, a slot 12, for the insertion of a memory card 42, a slot or port 14, such as, a slot 14, for a USB connection 44, a port 16, such as, for an external connection 46, or a video output port 16, a screen 17, as more clearly shown in FIGS. 2, 4, and 5, and at least one switch or button 18. The probing unit 20, preferably comprises of a hollow rigid tube 22, having a proximal end 19, and a distal or peripheral end 24, and an end cap 21. It is preferred that the first surface 11, has the screen 17, while the second surface 13, has the probing tube 20. It is also preferred that other components, such as, slots or ports 12, 14, 16, along with other electronic components 42, 44, 46, are along the peripheral wall 15.

FIG. 1B, illustrates an enlarged distal view of the inventive borescope apparatus 23, of FIG. 1A. The enlarged view of the distal end 24, of the probing unit 20, shows the hollow tube 22, preferably having at least one hole or opening 26, for at least one light source 25, such as, a LED light source 25, and at least one hole or opening 28, for at least one image sensor or camera 27. The probing unit 20, has an axial axis 79, and a radial axis 77, and wherein the proximal end 19, of the hollow rigid insertion tube 22, is axially securely mated with second surface 13, of the main body 10, and wherein the at least one light source 25, and the at least one imaging sensor 27, are along the radial axis 77, of the insertion tube 20. However, for some applications the hollow rigid insertion tube 22, could be axially securely mated with the peripheral surface 15, of the main body 10. For some applications it is preferred that the holes or openings 26, 28, are protected via a transparent media 29, such as, glass 29, window 29.

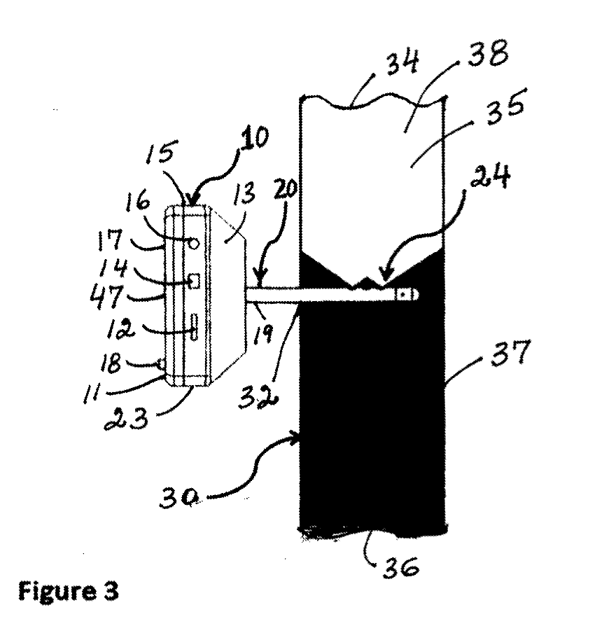

The battery operated inspection camera 23, comprising the main body 10, the hollow protruding solid or rigid tube 22, has the distal or peripheral end 24, and at the distal end 24, there are preferably an array of LEDs 25, which are used for scene illumination, as shown in FIG. 3, and at least one image sensing device 27. The distal end 24, is preferably at the tip of the protruding rigid insertion tube 20, which is connected to the main body 10. The probing tube or unit 20, could be connected or secured to the main body 10, via a number of ways, such as, for example, it could be either as a fixed connection, a flexible connection, or even a removable connection to the main body 10. There are various mechanical and electrical connectors that will allow for quick assembly and removal of the probing tube 20, from the main body 10.

FIG. 2, illustrates a perspective view of the borescope apparatus 23, showing a screen 17, and related components. The screen 17, could be a video screen 17, a LCD display screen 17, a touch-type screen 17, a camera screen 17, to name a few. The one or more switches 18, can be used for operating the borescope apparatus 23, such as, to activate or deactivate the light source 25, the turning ON or OFF of the image sensor 27, or camera 27, the image enhancement switch for different lighting conditions, the viewing of the images on the screen 17, to name a few. The screen 17, could be used play or record a video 47, or play back a still or video image 47, on the attached video or LCD screen 17, etc. For some applications the buttons or switches 18, could be touch sensitive button or switches 18, that could appear onto the screen 17. It should be appreciated that the switch 18, could be used to turn the LED 25, ON or OFF, or to control the light intensity in the cavity 38, by dimming LEDs 25.

FIG. 3, illustrates a side cut-away view of the borescope apparatus 23, showing the probing tube 20, as inserted through a wall 30. When an inspection or probing of a wall or ceiling 30, is desired one would make a small hole or opening 32, on the desired surface or location on the wall or ceiling 30. It is preferred that the hole or opening 32, is just slightly larger than the corresponding cross-sectional area of the probing tube or unit 20. Once the hole 32, has been made the probing tube 20, is gently inserted into the hole 32, and into the cavity 38, that needs to be probed. Once inside the cavity 38, the light source 25, is activated or turned ON, and that would result in a lighted area 35, and a dark area 37. With the light source 25, activated, the image sensor 27, can now be activated or turned ON, to either view the inside of the cavity 38, or to take images 47, for the video screen 17, or a video 47, to be shown or displayed on the screen 17. As one can see that the upper area or portion 34, of the cavity 38, is light 35, due to the activation of the light source 25, while the lower area or portion 36, of the cavity 38, is dark 37, and nothing can be seen. However, the inventive borescope 23, can easily be rotated 360 degrees inside the cavity 38, to clearly see and/or capture the inside features of the cavity 38, and thus with a rotation, such as, a 180 degree rotation, the upper portion 34, would become dark 37, while the lower portion 36, would light up 35, as the light source 25, would be pointing towards the lower portion 36, of the cavity 38.

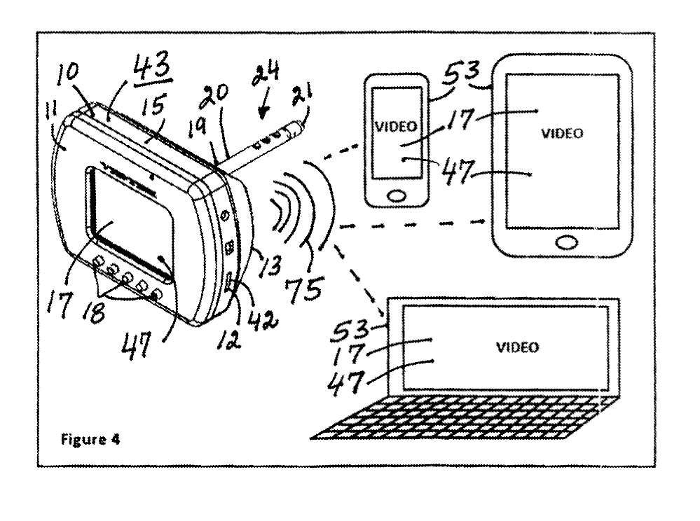

FIG. 4, illustrates a perspective view of a borescope apparatus 43, according to another embodiment of this invention. As shown in FIG. 4, the inspection camera 43, may transmit image or video signals 75, to an external device 53, such as, for example, a computer 53, smart-phone 53, a tablet 53, to name a few. This transmission 75, of the image or video 47, onto a screen 17, may be done in a number of manners, such as, for example, streaming of video 47, in a “network” fashion via Wi-Fi, or it may be done in an ad-hoc fashion where the connection is directly between the inspection camera 43, and the device 53, without the usage of an existing “network” 75. For some applications the transmission 75, could be recorded onto an external device 42, such as, a memory card 42.

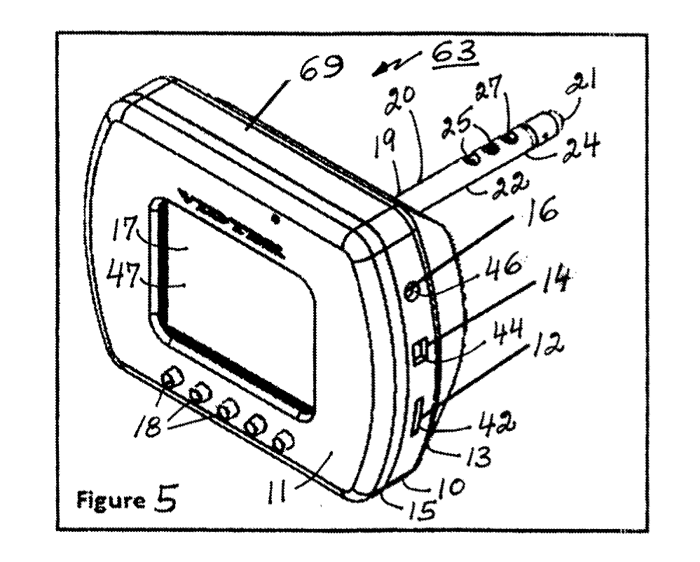

FIG. 5, illustrates a perspective view of a borescope apparatus 63, according to yet another embodiment of this invention. An antenna 69, could be secured to the main body 10, of the borescope 63. The antenna 69, could be used to wirelessly transmit 75, and/or receive 75, information from other devices or components 53.

It should be appreciated that the screen 17, of the inspection scope 23, can be used to see current or real-time images 47, coming from the probing tube 20, which would be the actual viewing of the images 47, captured by the image sensor 27, or it may be used to play back the images 47, going to or coming from the remote device 53, such as, for example, as shown in FIG. 4.

The invention may best be further understood by reference to the ensuing detailed description in conjunction with the drawings in which this new inventive battery operated inspection camera 23, 43, 63, allows for the smallest hole 32, for example, in the range of about 3 mm, to about 10 mm, to be made in an existing wall or ceiling 30, in order to ascertain the structure within a wall or a ceiling system 30. Using an array of light sources 25, such as, at least one LED 25, and at least one image sensor 27, which are preferably attached to a hollow solid and rigid tube 20, which allows for easy viewing of the interior 38, of the wall 30, on an attached screen 17, or an external viewing device 53, such as, for example, a computer 53, a tablet 53, a “smart phone” 53, to name a few. The rigid nature of this inspection camera 23, 43, 63, additionally gives a level of wider angle of view and/or visual precision which is not possible with other flexible camera systems or borescope for viewing inside, for example, walls or ceilings 30. This type of system is ideal for general building professionals who want a simple and minimally destructive or disruptive way to see inside, for example, walls 30, ceilings 30, or any other visually hidden space or surface 30, in order to make a proper assessment.

In one embodiment of the inventive borescope device 23, 43, 63, there may be no need for including an LCD screen 17, since the viewing 47, may be done solely on an external device 53, such as, a computer 53, a smart-phone 53, a tablet 53, to name a few, as more clearly shown in FIG. 4. Additionally the general shape of the apparatus 23, 43, 63, specially the viewing or main body segment 10, may look different as long as the rigid tubing 20, is still attached to it, allowing for a set of LEDs 25, and image sensor(s) 27, to be placed in such a way as was described earlier to enable the easy viewing of a cavity 38, of the wall 30, with a minimal creation of a hole or opening 32, in an existing wall 30.

It should be understood that the inventive inspection scope 23, 43, 63, has the main “control” unit 10, and which unit 10, houses the control logic, the video processing logic and all user interaction (UI) elements of the scope 23, 43, 63, including any and all buttons or switches 18. If the inspection camera 23, 43, 63, is intended to work wirelessly 75, with devices, as more clearly shown in FIG. 4, then the main body 10, should also include the wireless logic and antenna components 69. The functionality of the inspection camera 23, 43, 63, can vary depending on the implementation, however in one instance of this invention 23, 43, 63, there may be video output ports 16, on the main body 10, as well as various “memory slots” 12, that allow for a removable storage media 42, to be inserted into the device 23, 43, 63, for recording of either still images 47, or video segments 47.

As shown in FIG. 5, there may be a video out port 16, for connecting to an analog video display, such as, a TV, as well as a digital output port 14, which may be a USB 14, a Firewire 14, a HDMI (High-Definition Multimedia Interface) 14, or a number of other “digital” output ports 14, that allow for the transfer of images 47, and video 47, from the inspection camera 23, 43, 63, to a computer 53, or other computing device 53, such as, for example, a tablet 53, a smart-phones 53, to name a few. In addition, some versions of this inspection camera 23, 43, 63, may also include a “memory slot” 12, which will allow, for example, for the recording of still images 47, video segments 47, onto, for example, a memory media 42.

As this inventive device 23, 43, 63, is portable the main body 10, will also house the battery 70, for the unit 23, 43, 63. This battery 70, may be of the disposable kind, as well as, of a rechargeable variety. If it is rechargeable, then it may be charged with the batteries 70, remaining in the inspection camera 23, 43, 63, during charging—which can be accomplished with a charging circuitry in the main body 10, along with a connector that provides electrical connection, for example, to a power wall outlet. It should also be appreciated that the battery 70, or the rechargeable battery 70, could be charged via an electrical connection 12, 14, 16, or via a USB power port 12, 14, 16, or DC power input port 12, 14, 16, or by using an external power supply, to name a few.

The borescope or the optical monitoring system 23, 43, 63, allows for the transmission of images from an enclosed environment within the interior of a sealed wall 30, or ceiling 30, to an exterior location. As stated earlier that the cavity 38, or chamber 38, has walls 30, and an access port 32, or hole 32, that is created through the surface of the wall 30. The borescope system 23, 43, 63, comprises of a rigid, generally tubular, elongated, probing tube 20, that is preferably inside a sealed housing 20. The distal end 24, of the probe tube housing 20, preferably has a sealed window 29. For some applications it is preferred that the probing tube 20, from the distal end 24, to the proximal end 19, which is secured to the housing of the main unit 10, is environmentally or hermetically sealed. It is preferred that the interior of the probing tube housing 20, is accessible through an access port or hole from the interior of the housing of the main unit 10, including access to the electronics for the transmission media for transmitting images 47, of the interior of a cavity 38, that are obtained through a window 29, from the distal end 24, of the probe housing 20, along with the wiring for the light source 25, that are inside the probe housing 20.

The insertion tube 20, can be fashioned from a number of materials, including, for example, metals, aluminum, plastics, stainless steel, composite materials, to name a few. One important distinction for this segment of the inspection camera 23, 43, 63, is that the diameter or the cross-section of the tube 20, should be in the range of about 3 mm to about 5 mm, and it should be small enough that it can be inserted in a small hole 32, one which would require minimal cosmetic fixing/patching on the hole 32, after the inspection of the cavity 38.

The cross-sectional area for the inventive insertion tube 20, can be selected from a group comprising a triangle, a square, a rectangle, a circle, an oval, a polygonal shape, a cylindrical shape, and combinations thereof, to name a few.

The borescope apparatus 23, 43, 63, preferably has at least one transparent material 29, to environmentally protect the at least one light source 25, and the at least one imaging sensor 27. The at least one transparent material 29, could be selected from a group comprising glass, quartz, synthetic sapphire, polymeric material, composite material, and combinations thereof, to name a few.

The diameter or the cross-sectional area of the tube 20, preferably would correspond to an insertion hole 32, which is small enough where an operator, or a general contractor, or building owner, would be able to fill with wall/joint compound, and a simple spackling knife or their bare fingers after an inspection, as this is an important feature of this new borescope device 23, 43, 63.

The insertion tube 20, may be connected to the main body section 10, in a number of manners, which may include, but not limited to, being connected in a solid fashion, with a flexible joint, with a “ball-joint”, to name a few, and it may be removable so that it can be placed in a travel box or case (not shown). At the distal or peripheral end 24, of the tube 20, will be the segment where the LEDs 25, and the image sensor 27, will be preferably located. The LEDs 25, and the image sensor 27, will be configured onto the insertion tube 20, in a manner such that they will not interfere with the insertion of this tube 20, into a typical wall 30, once a small hole 32, or opening 32, has been created. Preferably, the LEDs 25, as well as the image sensor 27, will be encased inside the hollow rigid tube 22, in such a way to be water and dust proof. Although in FIG. 1B there are 2 LEDs 25, illustrated, there may be instances where more than 2 or even one LED 25, may be used, depending on the type of LED 25, deployed at the end of the tube 20, or the distal end 24. In fact, there may be instances where the LEDs 25, will be of various spectral wavelengths of light, both visible and non-visible, depending on the application of the inspection camera 23, 43, 63. The visible and non-visible LED lights 25, may or may not be present both at the same time on the same device 23, 43, 63, depending on the embodiment of the invention.

The connection may also utilize other wireless standards and protocols 75, for such external viewing devices 53, as appropriate in order to transmit the required still images 47, and video streams 47, in as close to real-time as possible. In instances of this invention where wireless streaming 75, of video 47, to an external device 53, is enabled, there may not be an LCD 25, or other viewing apparatus or component on the main body 10, of the inspection camera 23, 43, 63. The viewing functionality would then be performed by the external viewing device(s) 53. Additionally, since still images 47, and video 47, will be streamed to the viewing device 53, the storage of the images 47, and video clips 47, may also be saved on the viewing device 53, for example, a computer 53, a smart-phone 53, a tablet 53, to name a few.

It should be appreciated that at least one imaging sensor 27, could be selected from a group comprising a camera, a video camera, a still camera, an infrared camera, and combinations thereof, to name a few.

For some applications one could also have an LED intensity control dimming button or switch 18, which could be used to control the light intensity of the light source 25, or LED 25, while the probe 20, is inside the cavity 38, as desired.

It should be appreciated that the firmware on the microcontroller monitors all the functions of the inventive borescope 23, such as, for example, power state of the battery 70, the push button controls 18, video quality 47, on the screen 17, failure detection of any of the components of the borescope 23, to name a few.

The firmware on the microcontroller applies image enhancement methods to improve the video 47, or image quality 47, by utilizing various methods of image processing, such as, for example, color correction, noise reduction, smoothing, pixel intensity mapping gamma correction, to name a few.

The image enhancement can take place automatically by continuously getting feedback from camera sensor, and/or by applying image correction methods, which are well known in the art.

Hardware

1. Input power
1.1. Replaceable battery(s) 70
1.2. Rechargeable battery(s) 70
1.3. DC input 12, 14, 16
2. Camera board

### 2.1. Types

2.1.1. Flexible circuit

### 2.1.2. Rigid-flex

### 2.2. Components

2.2.1. Camera Sensor 27, can be an analog or a digital camera 27, providing, for example, VGA (640×480 Pixels). Camera sensor 27 can be upgraded to a higher resolution sensor 27.
2.2.2. Two or more white LEDs 25, for illumination purpose with dimming capability using Pulse Width Modulation (PWM) or analog voltage control

### 2.2.3. Infrared LED 25

2.2.4. Flexible cable: carries electrical signal and power to the camera sensor 27
2.2.5. Position and size: The width of the camera board assembly can be as small as 2 mm and its length, including the flexible cable, can be as long as four feet or longer. The camera 27, the LEDs 25, can all be in one row. Similarly, buttons 18, can all be in one row.

Main Board

3.1. Description: Mainboard is responsible for controlling system using a microcontroller unit (MCU) and also it supplies power to different components on the design.
3.2. The power circuitry on the main board protects the board from invalid input voltage such as reversed polarity circuitry, high voltage and electro static discharge.
3.3. Electrical interfaces
3.3.1. The mainboard has a connector interface to the camera board

### 3.3.2. Connector LCD

3.3.3. Programming and debugging interfaces, can be, for example, SPI, I2C, JTAG, UART, several test points, to name a few.

Display

3.4.1. The size of display 47, may vary from about 2.5 inches to about 10 inches. In the case of wireless video streaming 75, to a remote viewer 53, the display 47, on borescope 23, may not be needed.

Software

4.1. Initialization: Boots, initializes and programs the camera sensor, display and push button on the board
4.2. Monitoring battery level and system failures and takes required action repeatedly.
4.3. Battery power LED indicator. Indicates the current state of battery(s) by dimming, changing color and blinking
4.4. Image enhancement: Enhances image quality by adhering different methods of image processing such as color correction, noise cancellation, smoothing, pixel intensity mapping and gamma correction.

The tool used in the preset invention, namely, the borescope 23, 43, 63, may be implemented using one or more computers executing software instructions. According to one embodiment of the present invention, the borescope 23, 43, 63, may communicate with server and client computer systems 53 that transmit and receive data over a computer network or a fiber or copper-based telecommunications network 75. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus tools used in the present invention are not limited to any specific combination of hardware circuitry and software, nor to any particular source for the instructions executed by the server or client computers. In some instances, the client and server functionality may be implemented on a single computer platform.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A borescope apparatus, comprising;
(a) a main body, said main body having a first surface, a second surface, and a peripheral wall between said first surface and said second surface;
(b) a hollow rigid insertion tube having a proximal end, and a distal end, wherein said proximal end of said hollow rigid insertion tube is axially securely mated with said second surface of said main body; and
(c) wherein said distal end has at least one first opening for at least one light source, and at least one second opening for at least one imaging sensor.

2. The borescope apparatus of claim 1, wherein said first surface has at least one screen.

3. The borescope apparatus of claim 1, wherein said first surface has at least one screen, and wherein said screen is selected from a group consisting of a video screen, a touch screen, a camera screen, an LCD screen, and combinations thereof.

4. The borescope apparatus of claim 1, wherein said at least one light source is a LED.

5. The borescope apparatus of claim 1, wherein said at least one imaging sensor is selected from a group consisting of a camera, a video camera, a still camera, an infrared camera, and combinations thereof.

6. The borescope apparatus of claim 1, wherein said at least one light source, and said at least one imaging sensor are along the radial axis of said insertion tube.

7. The borescope apparatus of claim 1, wherein said main body has at least one means display an image from said at least one image sensor secured to said hollow rigid insertion tube.

8. The borescope apparatus of claim 1, wherein said main body has at least one means to wirelessly communicate with at least one electronic device.

9. The borescope apparatus of claim 1, wherein said main body has at least one means to wirelessly communicate with at least one electronic device, and wherein said at least one electronic device is selected from a group consisting of a smart phone, a tablet, a computer, a laptop, a mobile electronic device, and combinations thereof.

10. The borescope apparatus of claim 1, wherein said main body has at least one first switch to activate or deactivate said at least one light source.

11. The borescope apparatus of claim 1, wherein said main body has at least one second switch to activate or deactivate said at least one imaging sensor.

12. The borescope apparatus of claim 1, wherein said main body has at least one third switch to activate or deactivate communication to and from said at least one imaging sensor to a monitoring device.

13. The borescope apparatus of claim 1, wherein said main body has at least one port.

14. The borescope apparatus of claim 1, wherein said main body has at least one port, and wherein said port is selected from a group consisting of a video port, a digital port, a digital output port, a memory slot, a USB port, a Firewire port, a HDMI port, a digital output port, and combination thereof.

15. The borescope apparatus of claim 1, wherein material for said probe tube is selected from a group consisting of metal, aluminum, plastic, stainless steel, a composite material, and combination thereof.

16. The borescope apparatus of claim 1, wherein at least one transparent material environmentally protects said at least one light source, and said at least one imaging sensor.

17. The borescope apparatus of claim 1, wherein at least one transparent material environmentally protects said at least one light source, and said at least one imaging sensor, and wherein said at least one transparent material is selected from a group consisting of glass, quartz, a synthetic sapphire, a polymeric material, a composite material, and combinations thereof.

18. The borescope apparatus of claim 1, wherein said distal end has an image viewing end, and wherein said image viewing end is aligned with at least one sealed window.

19. The borescope apparatus of claim 1, wherein at least one battery is securely held inside said main body.

20. A method of inspecting a cavity in a structure, comprising the steps of;
(a) making a hole in said structure to access said cavity in said structure;
(b) inserting a distal end of a hollow rigid probe tube of a borescope inside said hole sufficient distance inside said cavity, and wherein said borescope has a main body secured to a proximal end of said hollow rigid probe tube, said distal end of said hollow rigid probe tube having at least one light source and at least one image sensor;
(c) activating said at least one light source, and said at least one imaging sensor to conduct internal inspection of said cavity; and
(d) removing said hollow rigid probe tube upon completion of said internal cavity inspection, and closing said hole in said structure.
